(19) United States
(12) Patent Application Publication
(10) Pub. No.: US 2011/0101931 A1
(43) Pub. Date: May 5, 2011

(54) Load adaptive DC Power Supply

(76) Inventor: Te-Cheng CHEN, Hsinchu County (TW)

(21) Appl. No.: 12/893,931

(22) Filed: Sep. 29, 2010

(30) Foreign Application Priority Data
Oct. 30, 2009 (TW) 098136808

(51) Int. Cl. G05F 1/46

(52) U.S. Cl. 323/234

(57) ABSTRACT

A load adaptive DC power supply circuit, comprising: a power converter, a current detector and a scan controller. The power converter provides an output voltage. The scan controller controls the power converter to change the output voltage and conduct voltage scanning. The current detector generates an output current signal according to the output current. The scan controller analyzes the output current signal and obtains an optimal output voltage.

### FIELD OF THE INVENTION

The present invention generally relates to a DC power supply circuit and, more particularly, to a load adaptive DC power supply circuit that is applicable to a constant-current load.

### BACKGROUND OF THE INVENTION

Please refer to FIG. 1, which is a schematic circuit diagram of a conventional LED lamp apparatus. The LED lamp apparatus comprises a power supply 12 and a plurality of light-emitting diode (LED) lamp series 14, 16, 17 and 18.

Each of the LED lamp series 14, 16, 17 and 18 respectively comprises a plurality of LEDs 141, 161, 171 and 181. Moreover, each of the LED lamp series 14, 16, 17 and 18 is respectively coupled to a constant-current driver (CCD) 143, 163, 173 and 183.

Due to process skews, the threshold turn-on voltage (Vt) of each LED 141, 161, 171 and 181 varies, and the current flowing through each constant-current driver 143, 163, 173 and 183 varies also. As a result, each LED lamp tube requires different driving voltages.

In order to drive each of the LED lamp series 14, 16, 17 and 18 without any problem, the power supply 12 is required to supply a voltage higher than the highest driving voltage of the LED lamp series.

However, as mass production is concerned, it is difficult for the manufacturers to check the driving voltage of each lamp tube one by one. Therefore, only the probable highest driving voltage is adopted as a reference of the output voltage from the power supply 12 according to possible skews on the production line. It is thus inevitable that most of the LED lamp series have to withstand a voltage higher than the driving voltages thereof, which resulting in larger power consumption and shorter lifetime of the devices.

### SUMMARY OF THE INVENTION

It is one objective of the present invention to provide a load adaptive DC power supply circuit that is applicable to a constant-current load.

It is another objective of the present invention to provide a DC power supply circuit with a power converter for converting an input voltage into an output voltage.

It is still another objective of the present invention to provide a DC power supply circuit with a scan controller for conducting voltage scanning to acquire an optimal output voltage.

It is still another objective of the present invention to provide a DC power supply circuit with a current detector for detecting the change of the output current.

It is still another objective of the present invention to provide a DC power supply circuit, wherein the scan controller comprises an analog-to-digital converter for converting the current signal into a digital signal.

It is still another objective of the present invention to provide a DC power supply circuit, wherein the scan controller comprises a micro-controller unit for analyzing the current signal and controlling the power converter to change the output voltage.

It is still another objective of the present invention to provide a DC power supply circuit, wherein voltage scanning is conducted with the output voltage changing from a low voltage to a high voltage to stably acquire an optimal output voltage.

It is still another objective of the present invention to provide a DC power supply circuit, wherein voltage scanning is conducted with the output voltage changing from a pre-determined voltage to a low voltage to quickly acquire an optimal output voltage.

The present invention provides a direct-current (DC) power supply circuit, comprising: a power converter connected to a power input terminal and a grounding terminal for converting an input voltage from the power input terminal into an output voltage; a current detector connected between the power converter and an output terminal of the DC power supply circuit for detecting the output current from the power converter and generating a current signal; and a scan controller connected to the power converter and the current detector for generating a control signal to control the power converter to generate a corresponding output voltage, wherein the output voltage is changed by changing the control signal to conduct voltage scanning, wherein the scan controller receives the current signal and determines whether the control signal is to be changed according to the current signal; wherein the scan controller generates an optimal control signal according to the change of the output current during voltage scanning when a load is connected between the output terminal and the grounding terminal, and then an optimal output voltage is obtained.

### BRIEF DESCRIPTION OF THE DRAWINGS

The objects and spirits of the embodiments of the present invention will be readily understood by the accompanying drawings and detailed descriptions, wherein:

FIG. 1 is a schematic circuit diagram of a conventional LED lamp apparatus;

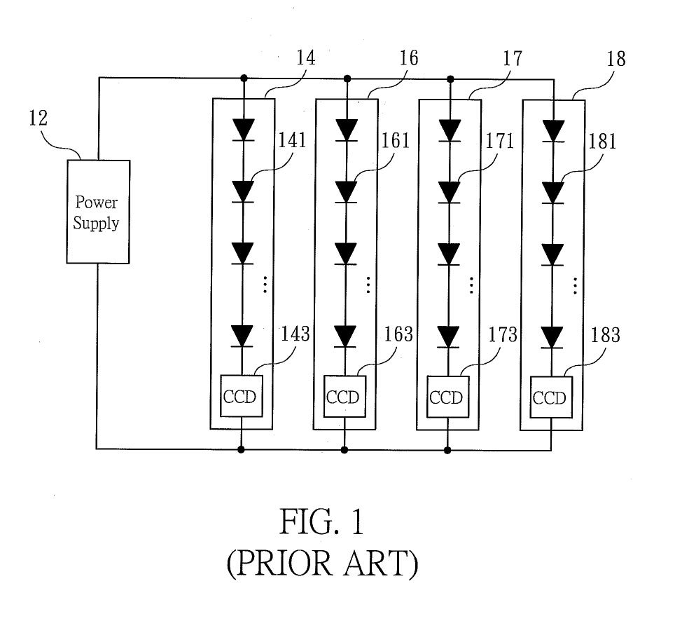

FIG. 2 is a schematic circuit diagram of a load adaptive DC power supply circuit according to one embodiment of the present invention;

FIG. 3 schematically shows voltage scanning according to one embodiment of the present invention;

FIG. 4 schematically shows voltage scanning according to another embodiment of the present invention;

FIG. 5 schematically shows various examples of the power converters according to the present invention;

FIG. 6 is a schematic circuit diagram of a load adaptive DC power supply circuit according to another embodiment of the present invention; and

FIG. 7 is a schematic circuit diagram of a load adaptive DC power supply circuit according to still another embodiment of the present invention.

### DETAILED DESCRIPTION OF THE PREFERRED EMBODIMENTS

The present invention can be exemplified but not limited by various embodiments as described hereinafter.

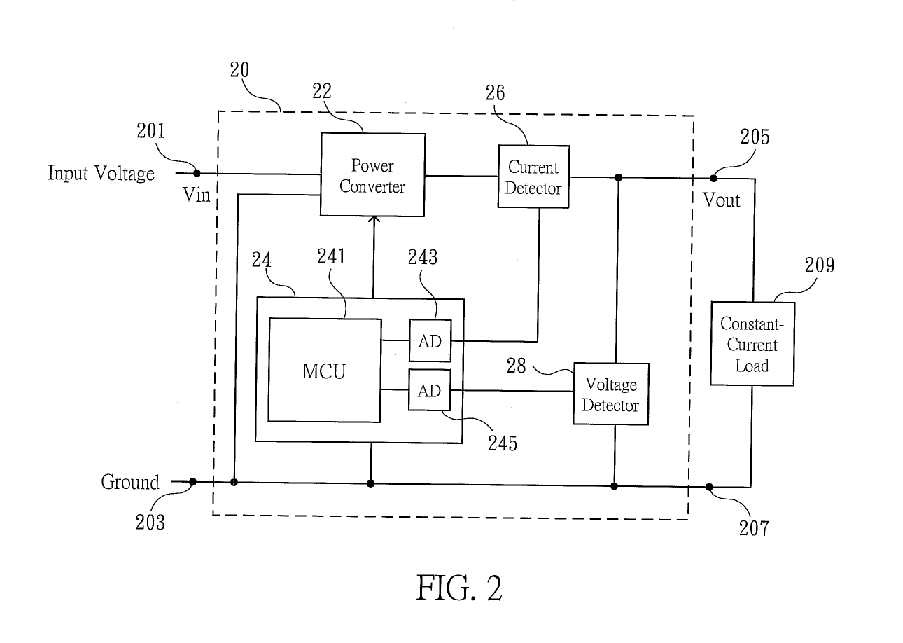

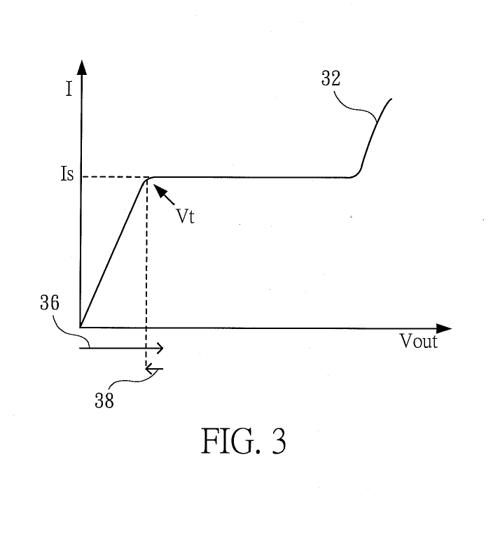

Please refer to FIG. 2 for a schematic circuit diagram of a load adaptive DC power supply circuit and FIG. 3 for voltage scanning according to one embodiment of the present invention. The load adaptive DC power supply circuit 20 of the present embodiment comprises a power converter 22, a current detector 26, a voltage detector 28 and a scan controller 24.

The power converter 22 is connected to a power input terminal 201 and a grounding terminal 203, and converts the input voltage Vin at the power input terminal 201 into an output voltage Vout at an output terminal 205. The current detector 26 is connected in series between the power converter 22 and the output terminal 205. The current detector 26 detects the output current from the power converter 22 and generates a current signal. The voltage detector 28 is connected between the output terminal 205 and grounding terminal 207 so as to detect the output voltage Vout from the power converter 22 and generate a voltage signal.

The scan controller 24 is connected to the power converter 22, the current detector 26 and the voltage detector 28. The scan controller 24 generates a control signal to control the power converter 22 to generate a corresponding output voltage Vout. In the present invention, the output voltage Vout is changed according to the change of the control signal. The scan controller 24 receives and analyzes the current signal and the voltage signal, and then determines whether the control signal is to be changed.

When the DC power supply circuit 20 is connected to a load 209, the scan controller 24 is capable of changing the output voltage Vout from the power converter 22 to conduct voltage scanning. An optimal control signal is thus generated according to the change of the output voltage Vout and current during voltage scanning, and an optimal output voltage with respect to the load 209 is obtained.

In one embodiment of the present invention, the scan controller 24 comprises two analog-to-digital converters 243, 245 and a micro-controller 241. The analog-to-digital converters 243 and 245 are connected to the current detector 26 and the voltage detector 28 respectively for converting the analog current and voltage signals generated by the current detector 26 and the voltage detector 28 into digital signals. The digital signals are then transmitted to the micro-controller unit 241 for analysis. The micro-controller unit 241 is capable of controlling the power converter 22 to change the output voltage Vout according to pre-determined scanning modes. As a result, an optimal output voltage can be obtained from the analysis of the digital signals.

As the DC power supply circuit 20 of the present invention is applied to a constant-current load 209, a threshold voltage Vt appears as a result of the current-voltage (I-V) characteristic curve 32, as shown in FIG. 3.

When the output voltage Vout is lower than the threshold voltage Vt, the current is linearly proportional to the output voltage Vout. As the output voltage Vout exceeds the threshold voltage Vt, the current no longer changes with the output voltage Vout and is fixed at a constant current Is.

Accordingly, in the present invention, the optimal output voltage is acquired by analyzing the change of the output voltage Vout and current.

In FIG. 3, the scan controller 24 controls the power converter 22 to conduct voltage scanning with the output voltage changing from a low voltage to a high voltage, as is indicated by the arrow 36 in FIG. 3. When the output voltage Vout exceeds the threshold voltage Vt of the constant-current load 209, the current is stabilized at Is and no longer changes with the output voltage Vout. Therefore, the scan controller 24 determines that the output voltage Vout before changing is adopted as the threshold voltage Vt of the constant-current load 209 when the output current changes within a variation smaller than a pre-determined value. As indicated by the arrow 38 in FIG. 3, the output voltage Vout is adjusted backwards as the optimal output voltage. The pre-determined value of the current variation can be determined to fall within a range (for example, below 5%) by the system designer.

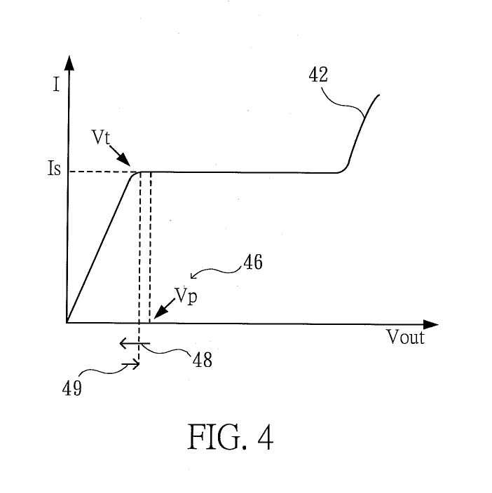

Please refer to FIG. 4, which schematically shows voltage scanning according to another embodiment of the present invention. In FIG. 4, the constant-current load 209 exhibits a current-voltage (I-V) characteristic curve 42 to identify a threshold voltage Vt. In the present embodiment, if the specification of a constant-current load 209 can be pre-known, it is possible to pre-determine a voltage Vp 46 according to the specification. Therefore, voltage scanning is conducted from the pre-determined voltage Vp 46 to a low voltage, as indicated by the arrow 48.

When the output voltage Vout changes and the current starts to change from the constant current Is with a variation larger than a pre-determined value, the output voltage Vout before changing is adopted as the threshold voltage Vt of the constant-current load 209. As indicated by the arrow 49 in FIG. 4, the output voltage Vout is adjusted backwards as the optimal output voltage. The pre-determined value of the current variation can be determined to fall within a range (for example, over 5%) by the system designer.

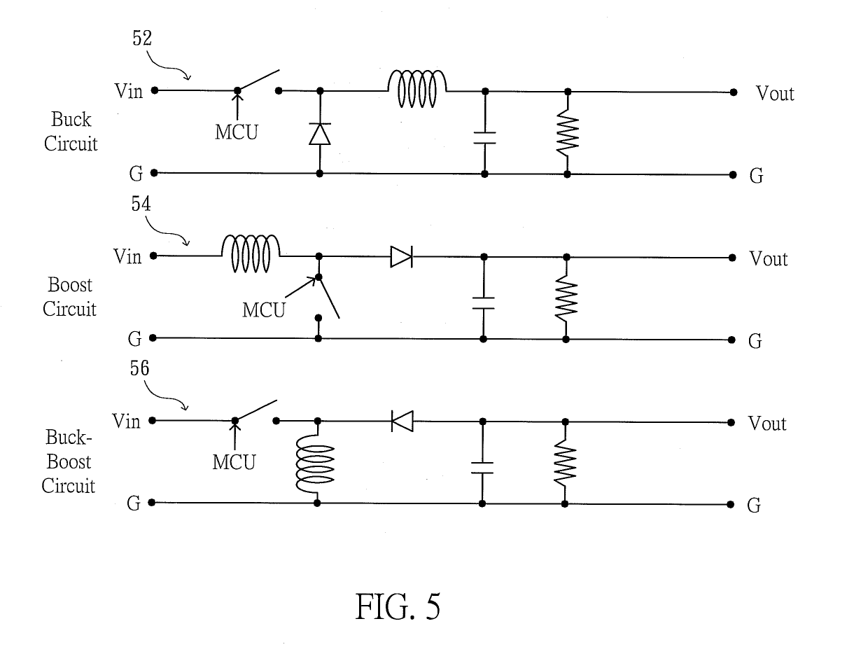

Please refer to FIG. 5, which schematically shows various examples of a power converter according to the present invention. Since the power converter is a well-known art in switching power applications, a few typical examples are presented herein for description. In FIG. 5, any of the buck circuit 52, the boost circuit 54 and the buck-boost circuit 56 can be used as the power converter 22 of the present invention.

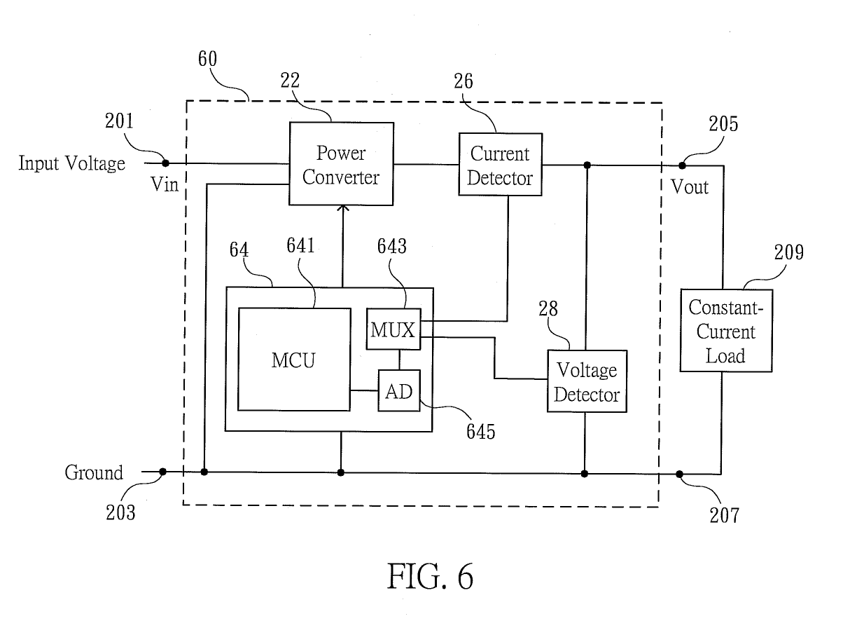

FIG. 6 is a schematic circuit diagram of a load adaptive DC power supply circuit according to another embodiment of the present invention. The DC power supply circuit 60 in FIG. 6 is similar to the embodiment in FIG. 2 except that the scan controller 64 of the DC power supply circuit 60 comprises a multiplexer 643 connected to the current detector 26, the voltage detector 28 and the analog-to-digital converter 645 so as to switch the analog current and voltage signals to the analog-to-digital converter 645 at different timings.

The analog-to-digital converter 645 converts the analog signals into the digital voltage signal and the digital current signal, and then transmits the digital signals to the micro-controller unit 641 to analyze the digital signals, and then the optimal output voltage will be obtained.

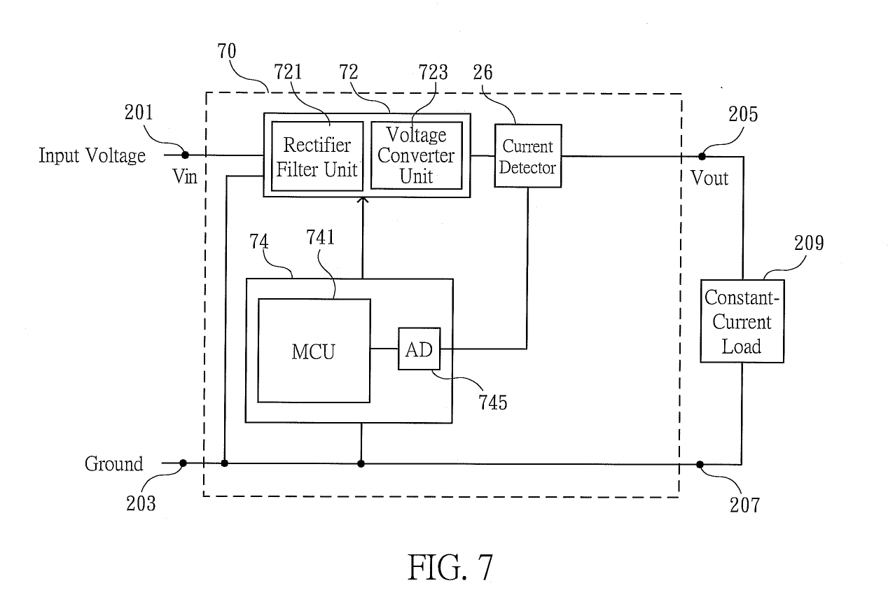

FIG. 7 is a schematic circuit diagram of a load adaptive DC power supply circuit according to still another embodiment of the present invention. In FIG. 7, the DC power supply circuit 70 is similar to the embodiment in FIG. 2 except that the DC power supply circuit 70 only comprises a current detector 26 to detect the output current.

When the input voltage is an AC voltage, the power converter 72 of the present invention may comprise a rectifier and filter unit 721 and a voltage converter unit 723. The rectifier and filter unit 721 rectifies and filters the AC voltage into a DC voltage, and then the voltage converter unit 723 converts the DC voltage into an output voltage.

The scan controller 74 of the present embodiment comprises a micro-controller unit 741 and an analog-to-digital converter 745. The analog-to-digital converter 745 is connected to the current detector 26 for converting the analog current signal into a digital signal, and transmits the digital signal to the micro-controller unit 741. The micro-controller unit 741 issues a control signal to control (the voltage converter unit 723 of) the power converter 72 to generate a corresponding output voltage, wherein the output voltage is changed by changing the control signal. The micro-controller unit 741 receives and analyzes the digital current signal and then determines whether the control signal is to be changed according to the digital current signal. When a load 209 is connected between the output terminal 205 and the grounding terminal 203, the micro-controller unit 741 issues an optimal control signal according to the variation of the output current during voltage scanning, and an optimal output voltage will be obtained.

In the present embodiment, the DC power supply circuit 70 can also be applied to a constant-current load 209. Accordingly, similarly to FIG. 3 and FIG. 4, voltage scanning in the present embodiment is conducted from a low voltage to a high voltage or from a pre-determined (higher) voltage to a low voltage.

In the foregoing embodiments, the constant-current load 209 can be implemented by using an LED lighting module. Moreover, the scan controller 24, 64 and 74 can be embedded in a control chip. Furthermore, the DC power supply circuit 20, 60 and 70 can be embedded in a power supply chip.

Moreover, the scan controller 24, 64 and 74 may conduct voltage scanning in a pre-determined period. In the case, when the number of LED lamp series is increased or reduced, the updated optimal output voltage can be obtained by periodically voltage scanning.

It is also possible to keep monitoring the output current and the output voltage after obtaining an optimal output voltage. Therefore, voltage scanning can be performed again when one of the output current or the output voltage changes. And then an updated optimal output voltage will be obtained.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A direct-current (DC) power supply circuit, comprising:
a power converter connected to a power input terminal and a grounding terminal for converting an input voltage from the power input terminal into an output voltage;
a current detector connected between the power converter and an output terminal of the DC power supply circuit for detecting the output current from the power converter and generating a current signal; and
a scan controller connected to the power converter and the current detector for generating a control signal to control the power converter to generate a corresponding output voltage, wherein the output voltage is changed by changing the control signal to conduct voltage scanning, wherein the scan controller receives the current signal and determines whether the control signal is to be changed according to the current signal;
wherein the scan controller generates an optimal control signal according to the change of the output current during voltage scanning when a load is connected between the output terminal and the grounding terminal, and then an optimal output voltage is obtained.

2. The DC power supply circuit as recited in claim 1, wherein the load is a constant-current load.

3. The DC power supply circuit as recited in claim 1, wherein voltage scanning is conducted with the output voltage changing from a low voltage to a high voltage.

4. The DC power supply circuit as recited in claim 3, wherein the output voltage before changing is adopted as the optimal output voltage when the output current changes within a variation smaller than a pre-determined value.

5. The DC power supply circuit as recited in claim 1, wherein voltage scanning is conducted with the output voltage changing from a pre-determined voltage to a low voltage.

6. The DC power supply circuit as recited in claim 5, wherein the output voltage before changing is adopted as the optimal output voltage when the output current changes with a variation larger than a pre-determined value.

7. The DC power supply circuit as recited in claim 1, wherein the scan controller comprises:
an analog-to-digital converter connected to the current detector for converting the current signal into a digital current signal; and
a micro-controller unit connected to the analog-to-digital converter for receiving and analyzing the digital current signal and controlling the power converter to change the output voltage and obtaining the optimal output voltage.

8. The DC power supply circuit as recited in claim 1, further comprising a voltage detector connected between the output terminal and the grounding terminal for detecting the output voltage from the power converter and generating a voltage signal, wherein the scan controller is connected to the voltage detector to receive the voltage signal and determine whether the control signal is to be changed according to the voltage signal.

9. The DC power supply circuit as recited in claim 8, wherein the scan controller comprises:
two analog-to-digital converters connected respectively to the voltage detector and the current detector for converting the voltage signal and the current signal into a digital voltage signal and a digital current signal; and
a micro-controller unit connected to the two analog-to-digital converters for receiving and analyzing the digital voltage signal and the digital current signal and controlling the power converter to change the output voltage and obtaining the optimal output voltage.

10. The DC power supply circuit as recited in claim 8, wherein the scan controller comprises:
an analog-to-digital converter for converting analog signals into digital signals;
a multiplexer connected to the current detector, the voltage detector and the analog-to-digital converter for switching the analog signals to the analog-to-digital converter so as to convert the analog signals into the digital voltage signal and the digital current signal at different timings; and
a micro-controller unit connected to the analog-to-digital converter for receiving and analyzing the digital voltage signal and the digital current signal and controlling the power converter to change the output voltage and obtaining the optimal output voltage.

11. The DC power supply circuit as recited in claim 8, wherein voltage scanning is performed when one of the output voltage or the output current changes after the scan controller obtains the optimal output voltage.

12. The DC power supply circuit as recited in claim 1, wherein the input voltage is selected from one of a DC voltage or an AC voltage.

13. The DC power supply circuit as recited in claim 12, wherein the power converter is selected from one of a buck circuit, a boost circuit or a buck-boost circuit.

14. The DC power supply circuit as recited in claim 12, wherein the power converter comprises the following elements when the input voltage is an AC voltage:
a rectifier filter unit for rectifying and filtering the AC voltage into a DC voltage; and
a voltage converter unit for converting the DC voltage into the output voltage.

15. The DC power supply circuit as recited in claim 14, wherein the voltage converter unit is selected from one of a buck circuit, a boost circuit or a buck-boost circuit.

16. The DC power supply circuit as recited in claim 1, wherein the load is a LED lighting module.

17. The DC power supply circuit as recited in claim 1, wherein the scan controller is a control chip.

18. The DC power supply circuit as recited in claim 1, wherein the DC power supply circuit is embedded in a power supply chip.

19. The DC power supply circuit as recited in claim 1, wherein the scan controller conducts voltage scanning in a pre-determined period.

20. The DC power supply circuit as recited in claim 1, wherein voltage scanning is performed when the output current changes after the scan controller obtains the optimal output voltage.
